(19) United States
(12) Patent Application Publication
(10) Pub. No.: US 2015/0343440 A1
(43) Pub. Date: Dec. 3, 2015

(54) METHOD OF BONDING FLUID DEVICE

(71) Applicant: CANON KABUSHIKI KAISHA, Tokyo (JP)

(72) Inventor: Eishi Igata, Port Washington, NY (US)

(21) Appl. No.: 14/712,217

(22) Filed: May 14, 2015

(30) Foreign Application Priority Data
May 27, 2014 (JP) 2014-108918

(51) Int. Cl. B01L 3/00; B32B 37/12; B32B 37/18

(52) U.S. Cl. CPC B01L 3/502707; B32B 37/18; B32B 37/12; B01L 3/502715; B01L 2200/12; B01L 2300/0887

(57) ABSTRACT

Provided is a device including: a first substrate having a flat surface; a second substrate having a flat surface; and a recessed portion formed in at least one of the flat surfaces of the first substrate and the second substrate, the flat surfaces of the first substrate and the second substrate being bonded together using a solvent to form a hollow therebetween in which a contact angle between a portion of the flat surface in contact with the hollow and the solvent is larger than a contact angle between at least part of a portion of the flat surface that is not in contact with the hollow and the solvent.

### BACKGROUND OF THE INVENTION

1. Field of the Invention

The present invention relates to a plurality of substrates for, when the plurality of substrates are bonded together to form a fluidic channel, keeping a shape of the fluidic channel.

2. Description of the Related Art

In the field of analytical chemistry, it is a fundamental matter to acquire desired information such as a concentration and a component in order to verify a process or results of a chemical reaction or a biochemical reaction, and hence various devices and sensors have been proposed to acquire such pieces of information. A concept referred to as “micro total analysis systems (μ-TAS)” or “lab on a chip” has been known, which reduces sizes of such devices and sensors to a microscale level to achieve all processes up to acquisition of the desired information on a microdevice. This is a concept aiming at undergoing a process such as a chemical reaction, an enzyme reaction, or sample purification while causing a collected raw material or a raw sample to pass through a fluidic channel in the microdevice and finally acquiring the concentration of a component or the like included in a chemically synthesized product or the specimen. The analysis and the reaction inevitably handle a trace of solution or gas, and hence the fluidic channel and the device are often referred to as “microfluidic channel” and “microfluidic device”, respectively.

A microfluidic device is generally formed by bonding, to a substrate having a thickness of several millimeters or less and a surface area of several centimeters square or more, another substrate having a groove formed in a surface thereof that has sectional dimensions of 0.1 μm to 1,000 μm and a flat plate to be a ceiling or a floor of the fluidic channel. As a method for the bonding between the substrates, there are thermal bonding, anodic bonding, ultrasonic bonding, compression bonding after excimer light irradiation, compression bonding after softening a surface of each substrate with a solvent (hereinafter referred to as “solvent bonding”), bonding using an adhesive layer (hereinafter referred to as “adhesive bonding”), and the like. Among those, in the solvent bonding and the adhesive bonding, facilities for the bonding are simple and the device can be manufactured with simplicity. It is essential that, in the completed device, no bonding agent has entered the fluidic channel, and a method of preventing the bonding agent from entering the fluidic channel is disclosed (Japanese Patent No. 3880930).

When a microfluidic device is manufactured by bonding a plurality of substrates, if an adhesive enters and remains in a fluidic channel, the adhesive completely or partly clogs the fluidic channel to hinder the fluidic device from performing a desired function. Further, in the solvent bonding, if the used solvent remains in the fluidic channel, reaction in the fluidic channel may be inhibited. Further, dimensions of the fluidic channel in the microfluidic device are on the order of micrometers, and thus, only a subtly excessive supply of an adhesive or a solvent enters the fluidic channel with ease.

In the adhesive bonding disclosed in Japanese Patent No. 3880930, an adhesive fills a gap between surfaces to be adhered to form a fluidic channel due to capillary action. When an excessive amount of the adhesive is supplied, the adhesive is held in a clearance portion for an adhesive formed in the vicinity of the fluidic channel. However, only a subtly excessive amount of supply has an influence within the gap between the surfaces to be adhered, and thus, the adhesive may enter part of the fluidic channel before the entire gap between the surfaces to be adhered is filled with the adhesive. This tendency is more conspicuous when the fluidic channel is long and has a curved portion having a smaller radius. In the case of a microfluidic device having such a complicated shape, it is difficult to form the microfluidic device only by holding the excessive supply in the clearance portion for the adhesive.

### SUMMARY OF THE INVENTION

The present invention provides a flat surface that prevents, when a microfluidic device is formed, an excessive amount of adhesive or solvent from entering a gap between surfaces to be bonded.

According to one embodiment of the present invention, there is provided a device including: a first substrate having a flat surface; a second substrate having a flat surface; and a recessed portion formed in at least one of the flat surfaces of the first substrate and the second substrate, the flat surfaces of the first substrate and the second substrate being bonded together using a solvent to form a hollow therebetween. In the device, a contact angle between a portion of the flat surface in contact with the hollow and the solvent is larger than a contact angle between at least part of a portion of the flat surface that is not in contact with the hollow and the solvent.

According to one embodiment of the present invention, there is provided a method of bonding substrates of a device, the device including: a first substrate having a flat surface; a second substrate having a flat surface; and a recessed portion formed in at least one of the flat surfaces of the first substrate and the second substrate, the method including bonding the flat surfaces of the first substrate and the second substrate together using a solvent to form a hollow therebetween. In the method, a contact angle between a portion of the flat surface in contact with the hollow and the solvent is larger than a contact angle between at least part of a portion of the flat surface that is not in contact with the hollow and the solvent, and the solvent is supplied to the portion of the flat surface that is not in contact with the hollow, to thereby form the hollow.

According to the one embodiment of the present invention, an excessive amount of adhesive or solvent can be prevented from entering the gap between the surfaces to be bonded of the two substrates, and thus, it is possible to manufacture the microfluidic device in which an amount of the adhesive or the solvent remaining in the fluidic channel is reduced.

Further features of the present invention will become apparent from the following description of exemplary embodiments with reference to the attached drawings.

### BRIEF DESCRIPTION OF THE DRAWINGS

FIGS. 1A and 1B are perspective views illustrating a principle of the present invention.

FIG. 2 is a sectional view illustrating the principle of the present invention.

FIG. 3 is a graph showing calculation of the principle of the present invention.

FIG. 4 is a sectional view illustrating the principle of the present invention.

FIGS. 5A, 5B, 5C, and 5D are sectional views illustrating behavior of a solvent according to the present invention.

FIG. 6 is a sectional view illustrating an embodiment of the present invention.

FIG. 7 is a sectional view illustrating another embodiment of the present invention.

FIG. 8 is a sectional view illustrating still another embodiment of the present invention.

FIG. 9 is a sectional view illustrating yet another embodiment of the present invention.

FIG. 10 is a conceptual view illustrating yet another embodiment of the present invention.

### DESCRIPTION OF THE EMBODIMENTS

The present invention is hereinafter described in detail.

A device according to the present invention includes: a first substrate having a flat surface; a second substrate having a flat surface; and a recessed portion formed in at least one of the flat surfaces of the first substrate and the second substrate, the flat surfaces of the first substrate and the second substrate being bonded together using a solvent to form a hollow therebetween. In the device, a contact angle between a portion of the flat surface in contact with the hollow and the solvent is larger than a contact angle between at least part of a portion of the flat surface that is not in contact with the hollow and the solvent.

A method of bonding substrates of a device according to the present invention, the device including: a first substrate having a flat surface; a second substrate having a flat surface; and a recessed portion formed in at least one of the flat surfaces of the first substrate and the second substrate, includes bonding the flat surfaces of the first substrate and the second substrate together using a solvent to form a hollow therebetween. In the bonding method, a contact angle between a portion of the flat surface in contact with the hollow and the solvent is larger than a contact angle between at least part of a portion of the flat surface that is not in contact with the hollow and the solvent, and the solvent is supplied to the portion of the flat surface that is not in contact with the hollow to fill the portion of the flat surface in contact with the hollow due to capillary action, to thereby form the hollow.

A material of the flat surfaces of the substrates is not particularly limited insofar as the material can be applied to solvent bonding or adhesive bonding, and may be glass, silicon, plastic, ceramic, or the like.

The solvent may be a solution containing a solvent that can soften the flat surfaces of the first substrate and the second substrate, or a solution containing an adhesive. Note that, an adhesive is herein sometimes described as an example, but a solvent for solvent bonding may also be used.

It is only necessary that the hollow be shaped so as to have sectional dimensions of 0.1 μm to 1,000 μm. The hollow is not particularly limited and may be, for example, a fluidic channel, a recess, or a hole.

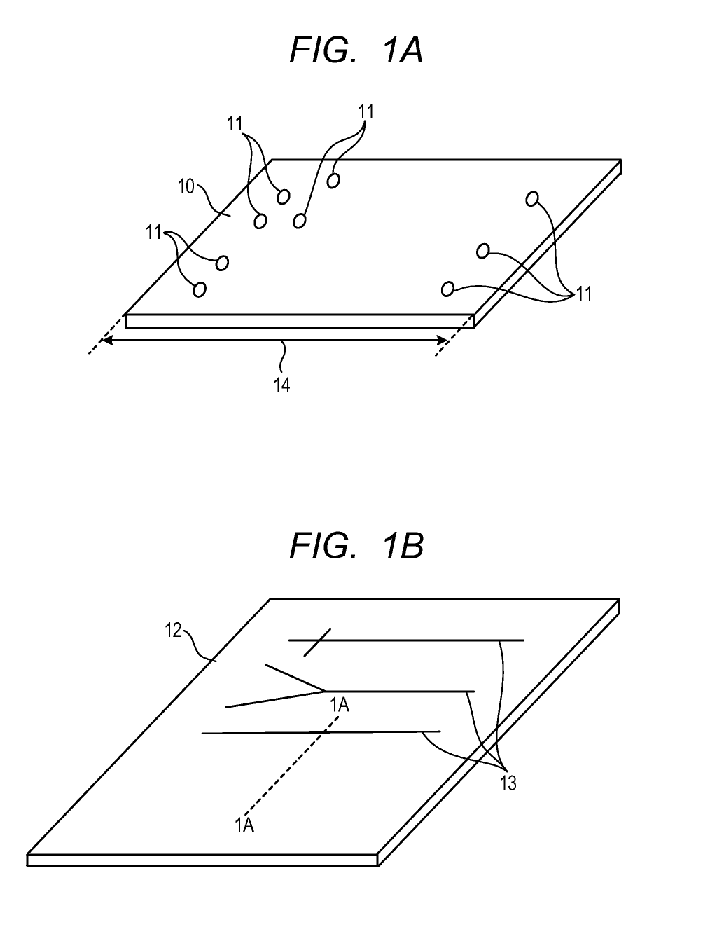

A principle of the present invention is now described with reference to FIGS. 1A, 1B, 2, 3, and 4.

With reference to FIG. 1A, a plurality of holes 11 are formed so as to pierce a substrate 10. A substrate 12 illustrated in FIG. 1B is to be bonded to the substrate 10 via an adhesive, and has grooves 13 formed in a surface thereof. An attempt is made to bond the substrate 10 and the substrate 12 together using the adhesive by bringing the substrate 10 and the substrate 12 into close contact with each other so that the holes 11 in the substrate 10 are aligned with ends of the grooves 13 in the substrate 12, respectively, and then introducing the adhesive into a gap therebetween.

A material of the substrate 10 and the substrate 12 is, for example, glass or plastic. It is only necessary that the grooves 13 have a width of about several micrometers to 1 mm, and a method of forming the grooves 13 greatly depends on the material of the substrates. For example, microprocessing using photolithography is used when the material is glass, and injection molding, hot embossing, or drilling is used when the material is plastic. However, the method is not particularly limited thereto.

The adhesive is not particularly limited, and may be, for example, a UV curable adhesive, a thermosetting adhesive, or a two-solution mixed adhesive.

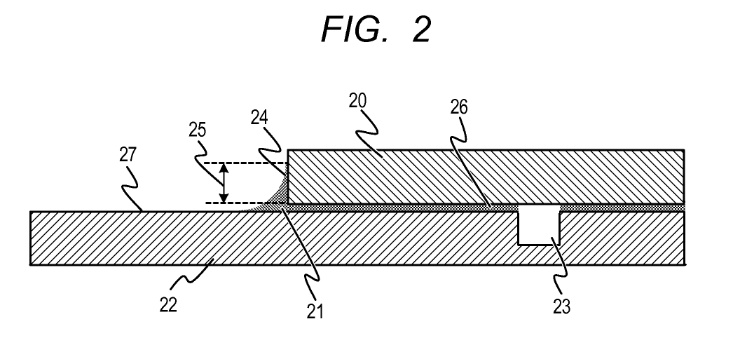

FIG. 2 is a sectional view of a portion corresponding to a portion taken along the line 1A-1A of FIG. 1B after the two substrates are brought into contact with each other. In this case, a state is illustrated in which the adhesive fills the gap and is still not cured. A substrate 20 and a substrate 22 having a groove 23 formed in a surface thereof are bonded together with an adhesive 21. Note that, under a state in which the substrate 20 and the substrate 22 are bonded together, the groove 23 is referred to as a fluidic channel 23. A gap 26 between the substrate 20 and the substrate 22 to be bonded is filled with the adhesive 21, and thus, a further supply of the adhesive becomes excessive. However, in reality, it is difficult to stop the supply when the amount of the adhesive becomes appropriate, and thus, an excessive amount of the adhesive is supplied. The excessive amount of supply generates a meniscus 24 on a side surface of the substrate 20 and on an upper surface of the substrate 22. Pressure in accordance with a height 25 of the meniscus 24 acts on the gap 26, which sometimes causes the adhesive 21 to enter the fluidic channel 23.

In other words, if a hydraulic pressure caused by the meniscus 24 is lower than a conduit resistance in the gap 26, the excessively supplied adhesive 21 cannot enter the gap 26, and thus, the adhesive 21 does not enter the fluidic channel 23. When a width of the gap (in a depth direction of the sheet in FIG. 2) is sufficiently larger than an interval of the gap, a pressure condition (index P) under which the adhesive 21 does not enter the fluidic channel 23 is that a difference between the conduit resistance and the hydraulic pressure is larger than zero, which is expressed as follows:

$$P = \frac{6}{Re} \frac{L}{2 b} \frac{ρ {v}^{2}}{2} - ρ g ( h + \frac{b}{2} ) > 0 \qquad ( 1 )$$

where ρ is a density of the adhesive, g is a gravitational acceleration, b is an average interval of the gap, L is a distance between a position from which the adhesive is injected to the fluidic channel 23, Re is a Reynolds number, which is about 1×10⁻⁶ to 100 in the case of a microfluidic channel, v is an average velocity of the adhesive 21 flowing through the gap and is determined based on the Reynolds number, and h is the height 25 of the meniscus 24 from a lower surface of the substrate 20. When a width of the device denoted by 14 in FIG. 1A is represented by a and the meniscus 24 is substantially arc-shaped, a calculation can be made as follows with regard to an excessive amount V of supply:

$$h = \sqrt{\frac{V}{a ( 1 - \frac{π}{4} )}} \qquad ( 2 )$$

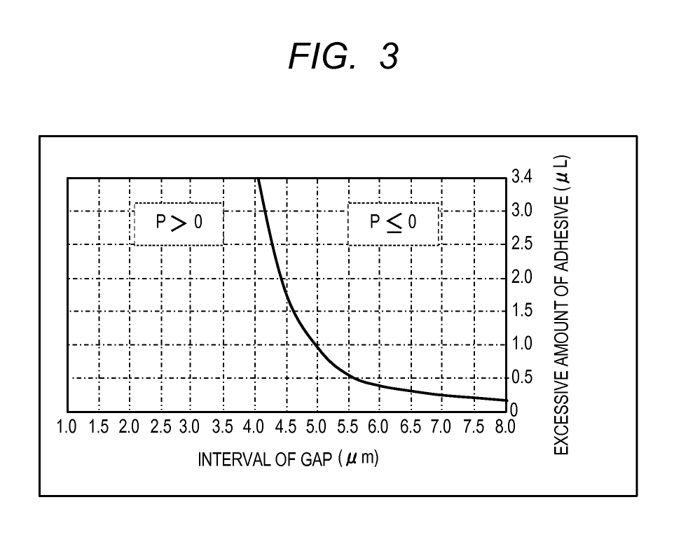

Formula (2) is substituted into Formula (1). In this case, the width a of the device is 10 mm, the density ρ of the adhesive is 1 g/cm³, the Reynolds number Re is 1×10⁻⁶, the distance L is 875 μm, a viscosity of the adhesive is 50 mPa·s. When a condition of the pressure P=0 is used as a function of the excessive amount V of supply and the average interval b of the gap so as to solve the resultant formula, the result is as shown in FIG. 3.

A region in which the adhesive does not enter the fluidic channel, that is, a region in which a pressure condition P>0 holds is expressed as a region below the plots in the graph of FIG. 3. The region means that the interval b is small or the amount V of supply is small. In particular, when the amount of supply is about 3 μl, or less and the interval is 4 μm or less, independently of the amount of supply of the adhesive, the adhesive does not enter the fluidic channel. Further, even if the excessive amount of supply is small, as the interval of the gap becomes larger, the state approaches a pressure condition of P≦0, and thus, the adhesive becomes more liable to enter the fluidic channel.

Further, it is shown that the fact that there is a region in which the condition expressed by Formula (1) does not hold even if the excessive amount of supply of the adhesive is small means that, even a subtly excessive supply of the adhesive like the meniscus 24 illustrated in FIG. 2 sometimes cannot be permitted in forming the fluidic channel 23. Therefore, in order to form the fluidic channel 23 that the adhesive 21 does not enter, it is important that, even when the adhesive 21 is excessively supplied, the meniscus 24 be prevented from being formed.

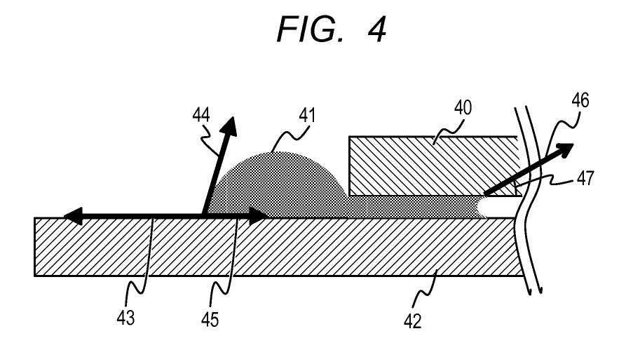

As a method of preventing the meniscus 24 from being formed, a method is thought of in which the excessive amount of the adhesive is let escape to a flat surface 27 as a portion of the substrate 22 that is not covered with the substrate 20, which is described with reference to FIG. 4.

FIG. 4 illustrates a state at the moment when, in bonding a substrate 40 and a substrate 42 together using an adhesive 41, the adhesive 41 is dropped to a flat surface as a portion of the substrate 42 that is not covered with the substrate 40. Interfacial tension acts between the adhesive 41 that is dropped in the air and the flat surface of the substrate 42, and between the adhesive 41 and the air. With reference to FIG. 4, interfacial tension (σ_{S}) 43 acts between the air and the substrate 42, interfacial tension (σ_{L}) 44 acts between the air and the adhesive 41, and interfacial tension (σ_{LS}) 45 acts between the adhesive and the substrate 42. A relationship F_{S} among the interfacial tensions causing the adhesive 41 to spread on the substrate 42 is expressed as:

F_{SS}=σ_{S}−(σ_{LS}+σ_{L})>O

On the other hand, the adhesive 41 progresses through the gap between the substrate 40 and the substrate 42 due to capillary action, and thus, an interfacial tension 46 (F_{C}) is expressed as:

F_{C}=σ_{L} cos θ

where θ is a contact angle 47. F_{S} induces a force toward a left end of the substrate 42 and F_{C} induces a force toward a right end of the substrate 42 in FIG. 4. If the entire amount of the dropped adhesive 41 flows toward the left end of the substrate 42, the gap cannot be filled, and thus, the relationship between F_{S} and F_{C} is required to be F_{C}>F_{S}. Therefore, the adhesive 41 does not flow toward the left end of the substrate 42 and can enter the gap to bond the substrate 40 and the substrate 42 together when the following relationship holds:

F_{C}=σ_{L} cos θ

σ_{L}(1+cos θ)>σ_{S}−σ_{LS} (3)

Exemplary combinations of the adhesive and the substrates that satisfy Formula (3) can include substrates each having a PMMA surface (σ_{S}≈41 mN/m) as the substrate 40 and the substrate 42 and an adhesive having σ_{L} of about 73 mN/m). This combination forms the meniscus 24 illustrated in FIG. 2. The excessive amount of supply of the adhesive may cause the adhesive to enter the fluidic channel 23 illustrated in FIG. 2.

When a combination with which Formula (3) does not hold, that is, the following formula holds is considered:

σ_{L}(1+cos θ)≦σ_{S}−σ_{LS} (4)

the combination may be, for example, substrates each having a PMMA surface (σ_{S}≈41 mN/m) as the substrate 40 and substrate 42 and an adhesive having σ_{L} of about 18 mN/m. In this case, the meniscus 24 illustrated in FIG. 2 is not formed, and at the same time, no capillary action is caused in the gap between the substrate 40 and the substrate 42. Therefore, gas-liquid interfacial tension is not caused at a position in contact with the fluidic channel 23 illustrated in FIG. 2, and thus, the adhesive enters the fluidic channel 23.

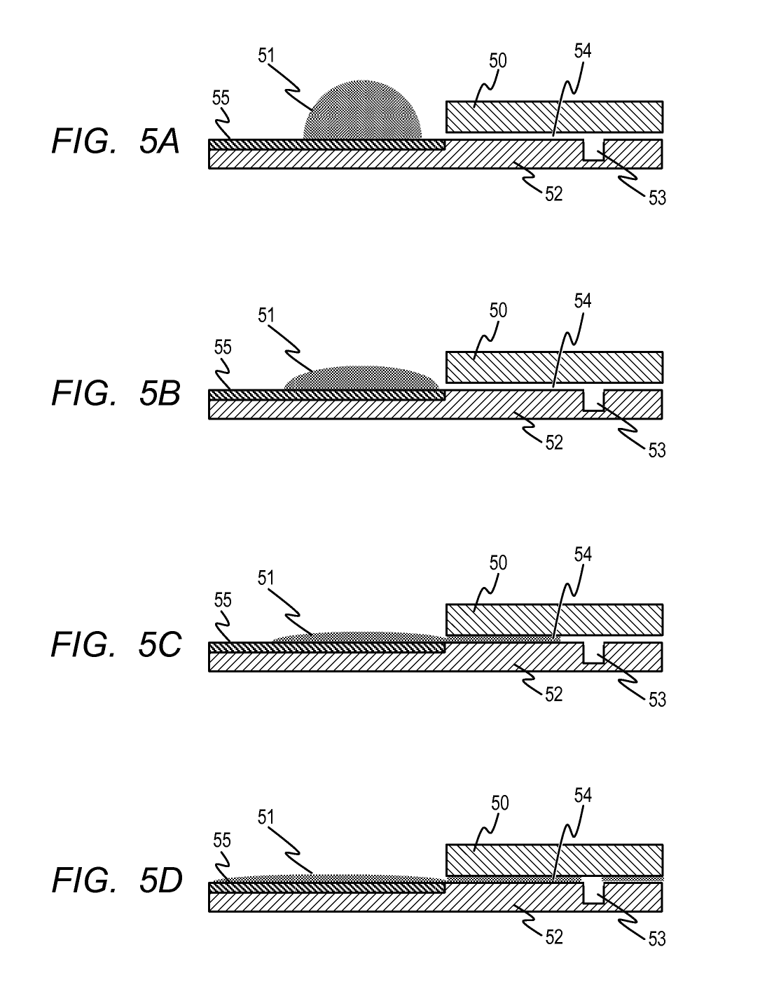

From the above, it can be understood that, in order to prevent a meniscus from being formed at an adhesive injection port, and to prevent the adhesive from entering the fluidic channel due to meniscus generated at a gas-liquid interface of the adhesive in the vicinity of the fluidic channel, it is only necessary to produce the flat surface that satisfies both Formula (3) and Formula (4) at the same time. This is exemplified in the following with reference to FIGS. 5A to 5D.

A substrate 50 and a substrate 52 are formed of a polycarbonate (having σ_{S} of about 40 mN/m). A copper thin film is formed on a flat surface 55 as a portion of the substrate 52 that is not covered with the substrate 50. Interfacial tension between copper and the air is about 1,100 mN/m, and thus, an adhesive having a surface tension of 20 mN/m to 100 mN/m satisfies Formula (4). Accordingly, an adhesive 51 dropped to the flat surface 55 (FIG. 5A) spreads without forming a meniscus at the injection port (FIG. 5B). When the adhesive enters a gap 54 between the polycarbonate substrates, capillary action is caused in the gap 54, and the adhesive fills the gap 54 (FIG. 5C). In this case, at the position in contact with a fluidic channel 53, due to the gas-liquid interfacial tension, the adhesive does not enter the fluidic channel 53 also in this case. Further, even if an excessive amount of the adhesive is supplied, a meniscus is not formed at the injection port and no excessive pressure is applied thereby, and thus, the adhesive 51 does not enter the fluidic channel 53 (FIG. 5D).

The fact that the interfacial tension on the flat surface 55 is large means, in other words, that a contact angle of the adhesive 51 with respect to the flat surface is small. The adhesive 51 spreads, and thus, it is preferred that the contact angle between the adhesive 51 and the flat surface 55 be 0°. In this case, the adhesive spreads in accordance with spreading wetting. On the other hand, in the gap 54, a meniscus is formed with a contact angle, and the adhesive 51 is prevented from entering the fluidic channel 53. Therefore, to adjust magnitude of the interfacial tension is to keep the appropriate contact angle.

Further, it is preferred that the contact angle with respect to the flat surface 55 be 0°, but a value close to 0° is permissible. When the adhesive 51 is dropped to the flat surface 55 and spreads, if the spread liquid droplet has an interval that is smaller than the interval of the gap 54, the spread liquid droplet does not have such an interval due to an excessive supply of the adhesive. A condition for this is determined.

When the adhesive 51 is dropped to the flat surface 55 with the contact angle being substantially 0° and spreads, the spread adhesive 51 is substantially in the shape of a circular cone. An amount V of supply of the adhesive is a volume of the circular cone, and thus, has the following relationship:

$$V = \frac{π}{3} {( \frac{h}{tan θ} )}^{2} h$$

where h is a height of the circular cone and θ is a contact angle. It is only necessary that a solution for h be smaller than a height b of the gap. Therefore, the following formula is solved:

$$h = \sqrt[3]{\frac{3 {tan}^{2} θ}{π} V} < b$$

to obtain the following relationship:

$$θ < {tan}^{- 1} \sqrt{\frac{π {b}^{3}}{3 V}}$$

When the gap 54 is 3 μm and the amount V of supply of the adhesive is 1 μL, θ is about 0.01°, which is hereinafter referred to as “substantially 0°”.

Note that, exemplary methods for reducing the contact angle with respect to a substrate material that cannot be coated with a metal include various kinds of chemical hydrophilic treatment represented by spraying an ultra-hydrophilic material, ultraviolet irradiation, excimer light irradiation, corona plasma irradiation, and ultraprecision grinding, and any one of those methods may be used as appropriate.

The present invention uses the principle described above, and provides a flat surface that prevents, when a solvent or an adhesive is used to manufacture a microfluidic device, the solvent or the adhesive from entering the fluidic channel.

Now, the present invention is described further specifically by way of examples. Note that, the following examples are shown merely for describing the present invention in more detail, and the present invention is not limited to the following examples.

### Example 1

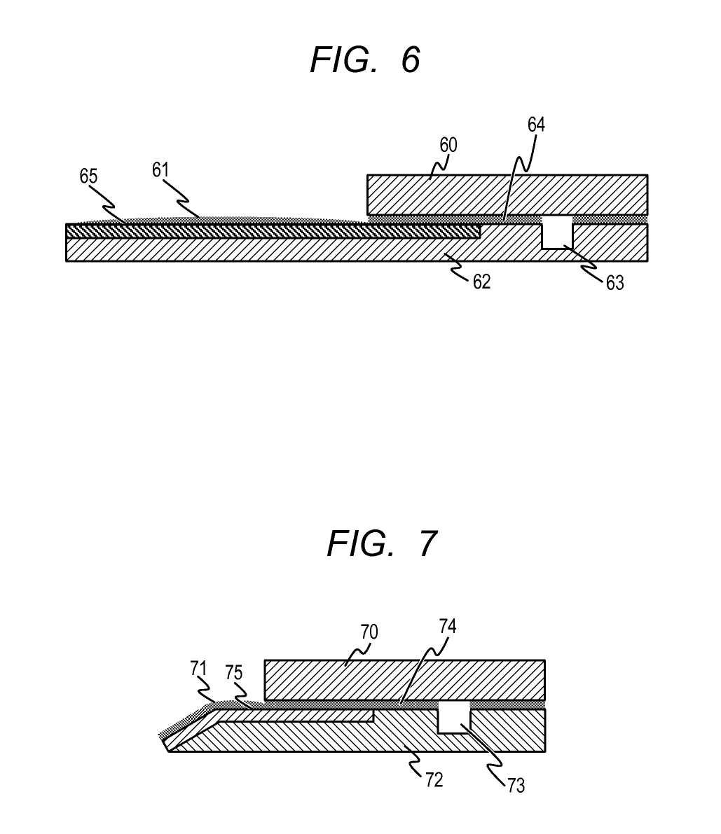

Example 1 is described with reference to FIG. 6. With reference to FIG. 6, an adhesive 61 fills a gap 64 between a substrate 60 and a substrate 62 to form a fluidic channel 63. A flat surface 65 formed on the substrate 62 has a contact angle of substantially 0° with respect to the adhesive 61.

The adhesive 61 that is dropped to the flat surface 65 spreads on the flat surface 65 to enter the gap 64. However, in this case, the adhesive 61 has a contact angle of 0° with respect to the flat surface 65 in the gap 64, and thus, no capillary action is caused. When the adhesive 61 reaches a right end portion of the flat surface 65, capillary action starts to act between the substrate 60 and the substrate 62, and the adhesive 61 fills the gap 64 without entering the fluidic channel 63 at a position in contact with the fluidic channel 63 due to surface tension. When the gap 64 is completely filled, due to a high conduit resistance of the gap 64, even if an excessive amount of the adhesive is supplied, the adhesive does not enter the gap 64 and spreads on a flat surface as a portion of the substrate 62 that is not covered with the substrate 60.

A periphery of the fluidic channel 63 is a region in which a gas-liquid interface is required to be formed at a position where the adhesive 61 is in contact with the air, and a size of the region is determined as follows. Capillary action acts on a liquid that progresses through a space formed with the gap height b and the device width a denoted by 14 in FIG. 1A in a progress direction, and at the same time, friction force between the substrate and the liquid acts in a direction opposite to the progress direction. Note that, the substrate is set in a direction perpendicular to the direction of gravity so that influence of gravity may be neglected. Temporal change in kinetic momentum of the liquid that has progressed through the gap by the distance L in this case is equal to difference between the capillary action and the friction force, which is expressed by the following formula:

$$\frac{d}{d t} abL ρ v = 2 ( a + b ) σcos θ - \frac{12 a μ}{b} Lv \qquad ( 5 )$$

where ρ is a density of the liquid, σ is a surface tension of the liquid, v is a velocity of the liquid, θ is a contact angle between the substrate and the liquid, and μ is a viscosity of the adhesive. Further, parameters that are not related to time are extracted as follows:

$$A = \frac{2 ( a + b ) σcos θ}{ab ρ}$$

$$B = \frac{12 μ}{{b}^{2} ρ}$$

and Formula (5) is solved to obtain:

$$L = \sqrt{\frac{2}{{B}^{2}} exp ( - Bt + {C}_{1} ) + \frac{2 A}{B} t + {C}_{2}}$$

where C₁ and C₂ are constants. A and B are again substituted into the formula above to obtain:

$$L = \sqrt{\frac{{b}^{2} ρ}{6 μ} exp ( \frac{- 12 μ t}{{b}^{2} ρ} + {C}_{3} ) + \frac{b}{6 a} \frac{2 ( a + b ) σcos θ}{μ} t + {C}_{4}} \qquad ( 6 )$$

thereby the distance L of progress is determined with respect to the constants C₃ and C₄. In this way, a second term of Formula (6) that is a nonexponential term is the Lucas-Washburn equation that describes that the distance L of progress is proportional to the square root of the time t. This shows a stable state of progress in which the distance of progress linearly increases as the time changes. In fact, even if a value of an initial velocity is changed in this state, the distance of progress is under control of the capillary action, and there is almost no influence. On the other hand, a first term of Formula (6) that is an exponential term has an influence only during a very short period of time immediately after the capillary action starts to act. In this state, a force rapidly acts due to interfacial tension of the substrate, and the distance L of progress rapidly increases nonlinearly. Therefore, a distance at which the capillary action becomes stable may be approximated as:

$$L = \sqrt{\frac{b}{6 a} \frac{2 ( a + b ) σcos θ}{μ} t} \qquad ( 7 )$$

It follows that the contact angle that is not 0° is formed around the fluidic channel so that the length of a normal from the fluidic channel is as expressed by Formula (7).

Note that, when a is 10 mm, b is 3 μm, σ is 50 mN/m, μ is 50 mPa·s, A is 10°, and the time t is 0.1 second, both of results of calculation of Formula (6) and Formula (7) are L=0.314 mm and thus match to each other. It is assumed that C₃=C₄=0.

The above shows that, even when a flat surface having a contact angle of substantially 0° exists immediately below the substrate 60, by securing a region around the fluidic channel in which capillary action acts with stability, an excessive amount of adhesive is prevented from entering the fluidic channel.

### Example 2

In Example 2, it is shown that the present invention is applicable to various other hollow shapes represented by a fluidic channel shape.

When an excessive amount of adhesive is supplied, in order to prevent the adhesive from entering a hollow, pressure applied to an injection port of the adhesive propagates through the gap, and the pressure is reduced to be lower than pressure applied to a meniscus at a gas-liquid interface formed in the hollow. This is qualitatively represented as follows:

(pressure applied to meniscus)>(pressure applied to injection port)−(pressure loss)

The above qualitative formula can be represented as follows:

$$\frac{2 ( {1}_{p} + b ) σcos θ}{{1}_{p} b} > ρ g ( \frac{V}{A} + \frac{b}{2} ) - \frac{3 μ v}{{( b / 2 )}^{2}} L \qquad ( 8 )$$

where lₚ is an outer peripheral length of the hollow shape, b is a height of the gap, σ is a surface tension of the adhesive, ρ is a density of the adhesive, μ is a viscosity of the adhesive, v is an average velocity of progress of the adhesive, θ is a contact angle between the adhesive and a flat surface forming the gap, L is a distance from the injection port to the hollow shape, g is a gravitational acceleration, V is an amount of supply of the adhesive, and A is an area in which the excessive amount of the adhesive spreads. A second term on the right side of Formula (8) is a term with regard to the pressure loss. When the formula needs to hold also at a position of L to 0, the second term on the right side is regarded as zero.

Formula (8) is solved for A to obtain:

$$A > V {\{ \frac{2 ( {1}_{p} + b ) σcos θ}{{1}_{p} b ρ g} - \frac{b}{2} \}}^{- 1} \qquad ( 9 )$$

The hollow shape in various shapes having an outer peripheral length lₚ can determine an area of the clearance for the excessive supply of the adhesive so that Formula (9) holds.

For example, when the amount V of supply of the adhesive is 1 μL, the hollow shape is a circle having a diameter of 100 μm, the height b of the gap is 3 μm, the surface tension a of the adhesive is 50 mN/m, the density ρ of the adhesive is 1,000 kg/m³, the viscosity μ of the adhesive is 50 mPa·s, and the contact angle θ between the adhesive and the flat surface forming the gap is 10°, the area A is 296 mm².

A case in which the hollow shape is a circle is exemplified, but the outer peripheral length lₚ does not limit the shape, and thus, the present invention is effective in forming a hollow in an arbitrary shape.

### Example 3

In Example 3, a method of dealing with a case in which the area of the device cannot satisfy Formula (9) in Example 2 is exemplified with reference to FIG. 7.

When the area A to which the adhesive can escape cannot satisfy Formula (9), if the adhesive does not overflow from a surface to which the adhesive is supplied, the excessive amount of the adhesive accumulates on the surface to which the adhesive is supplied. Similarly to the case of the height 25 of the meniscus 24 illustrated in FIG. 2, a certain height of meniscus is formed, which can be a pressure source to supply the adhesive into the gap of the substrates.

With reference to FIG. 7, an adhesive 71 fills a gap 74 between a substrate 70 and a substrate 72 to form a fluidic channel 73. In this case, a flat surface 75 having a contact angle of substantially 0° is tapered. When an excessive amount of the adhesive 71 is supplied, the excessive amount can fall from the substrate 72 more rapidly. In this way, the excessive amount of the adhesive can be prevented from increasing the height thereof. Further, according to the example illustrated in FIG. 7, the area of the substrate 72 can be reduced.

### Example 4

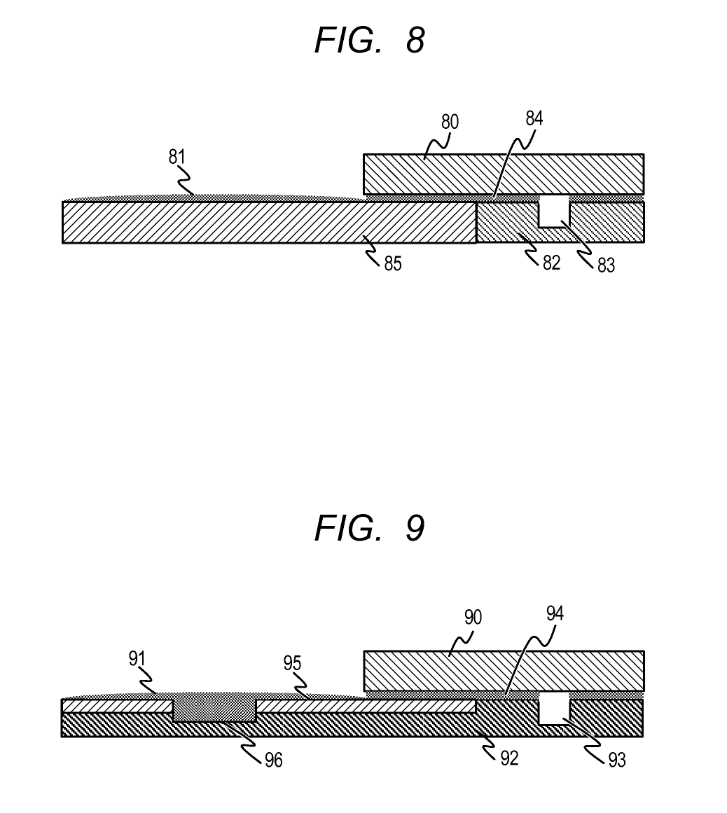

In Example 4, a case in which the flat surface having a contact angle of substantially 0° is not necessarily required to be formed on the substrate is described with reference to FIG. 8.

With reference to FIG. 8, an adhesive 81 fills a gap 84 between a substrate 80 and a substrate 82 to form a fluidic channel 83. A substrate 85 in close contact with a side surface of the substrate 82 has a contact angle of substantially 0° with respect to the adhesive 81.

The adhesive 81 that is dropped to the substrate 85 spreads on the substrate 85 to enter the gap 84. When the adhesive 81 reaches a right end portion of the substrate 85, capillary action starts to act between the substrate 80 and the substrate 82, and the adhesive 81 fills the gap 84 without entering the fluidic channel 83 at a position in contact with the fluidic channel 83 due to surface tension. When the gap 84 is completely filled, due to a high conduit resistance of the gap 84, even if an excessive amount of the adhesive is supplied, the adhesive does not enter the gap 84 and spreads on the substrate 85. Further, by physically separating the substrate 85 from the substrate 82, a further excessive supply is prevented. Further, as described in Example 3, the substrate 85 may be tapered and be in close contact with the substrate 82.

As described in the present example, even with regard to a material hydrophilic treatment or coating of which is difficult, by bringing the material into close contact with a substrate having a contact angle of substantially 0° with respect to an adhesive or a solvent, the present invention has an effect.

### Example 5

In Example 5, a supply flat surface that facilitates supply of an adhesive is exemplified with reference to FIG. 9.

With reference to FIG. 9, an adhesive 91 fills a gap 94 between a substrate 90 and a substrate 92 to form a fluidic channel 93. A flat surface 95 to which the adhesive is supplied has a contact angle of substantially 0°, and an adhesive receiving shape 96 for storing the adhesive 91 is formed in a portion of the flat surface 95 that is not covered with the substrate 90.

When the adhesive is supplied using a motor-driven syringe pump or the like, an amount of supply may sometimes fluctuate immediately after the syringe pump is actuated. By storing the initially fluctuated amount of the adhesive in the adhesive receiving shape 96 to perform the bonding using a supply of the adhesive after a predetermined time elapses and the supply velocity becomes steady, a more appropriate amount of the adhesive can be supplied with a higher degree of reproducibility. Further, by adjusting a capacity of the adhesive receiving shape 96, the adhesive can be supplied toward the gap 94 with higher precision. For example, when an instrument having a minimum amount of supply of 1 μL is used and the amount of the adhesive appropriate for filling the gap is 0.5 μL, the capacity of the adhesive receiving shape 96 may be set to be 0.5 μL.

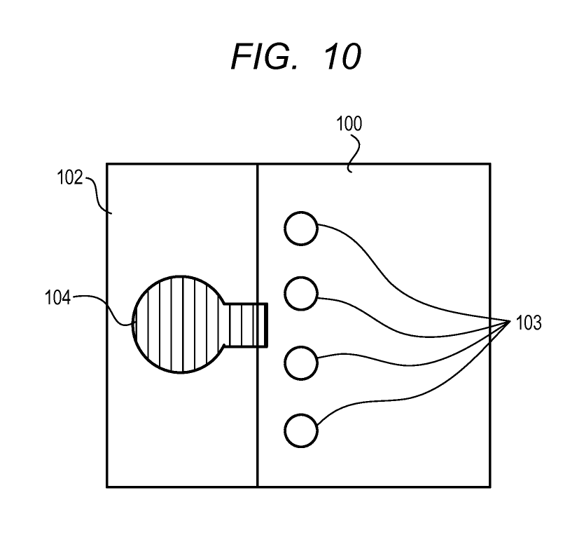

Further, when the amount of supply of the adhesive is required to be reduced, an adhesive guide may be formed as illustrated in FIG. 10. With reference to FIG. 10, under a state in which a substrate 100 is in close contact with an upper surface of a substrate 102, a hollow shape 103 is formed between the substrate 100 and the substrate 102. A region 104 is a region having a contact angle of substantially 0° with respect to the adhesive, and the remaining portion on the substrate 102 other than the region 104 has a contact angle of more than 0°. The adhesive dropped to the region 104 does not spread over the entire flat surface of the substrate 102, but first spreads in the region 104 with a flow direction thereof being limited. The region 104 also exists immediately under the substrate 100, and the spread adhesive fills a gap between the substrate 100 and the substrate 102 due to capillary action.

As described above, in order to facilitate supply of the adhesive, the flat surface having a contact angle of substantially 0° may have the adhesive receiving shape or may have the guiding function.

The present invention can be used for manufacturing a microfluidic device for performing a (raw) chemical reaction and (raw) chemical analysis.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-108918, filed May 27, 2014, which is hereby incorporated by reference herein in its entirety.

What is claimed is:

1. A device comprising:
a first substrate having a flat surface;
a second substrate having a flat surface; and
a recessed portion formed in at least one of the flat surfaces of the first substrate and the second substrate,
the flat surfaces of the first substrate and the second substrate being bonded together using a solvent to form a hollow therebetween,
wherein a contact angle between a portion of the flat surface in contact with the hollow and the solvent is larger than a contact angle between at least part of a portion of the flat surface that is not in contact with the hollow and the solvent.

2. The device according to claim 1, wherein Formula (1) holds:
$$L = \sqrt{\frac{b}{6 a} \frac{2 ( a + b ) σcos θ}{μ} t} \qquad ( 1 )$$
where L is a length of a normal from an outer periphery of the hollow on the portion of the flat surface in contact with the hollow, a is a width of the flat surfaces, b is a distance between the flat surfaces of the first substrate and the second substrate, σ is a surface tension of the solvent, θ is a contact angle between the flat surface and the solvent, μ is a viscosity of the solvent, and t is a time elapsed since the solvent is brought into contact with the normal.

3. The device according to claim 1, wherein Formula (2) holds:
$$θ < {tan}^{- 1} \sqrt{\frac{π {b}^{3}}{3 V}} \qquad ( 2 )$$
where θ is a contact angle between the at least part of the portion of the flat surface that is not in contact with the hollow and the solvent, b is a distance between the flat surfaces of the first substrate and the second substrate, and V is a volume of the solvent to be supplied.

4. The device according to claim 1, wherein Formula (3) holds:
$$A > V {\{ \frac{2 ( {1}_{p} + b ) σcos θ}{{1}_{p} b ρ g} - \frac{b}{2} \}}^{- 1} \qquad ( 3 )$$
where A is an area of the portion of the flat surface that is not in contact with the hollow, lₚ is an outer peripheral length of the hollow, b is a distance between the flat surfaces of the first substrate and the second substrate, σ is a surface tension of the solvent, θ is a contact angle between the flat surface and the solvent, ρ is a density of the solvent, and g is a gravitational acceleration.

5. The device according to claim 1,
wherein the portion of the flat surface that is not in contact with the hollow is adjacent to the portion of the flat surface in contact with the hollow, and the portion of the flat surface that is not in contact with the hollow is adjacent to an outer periphery of the device, and
wherein the contact angle between the portion of the flat surface that is not in contact with the hollow and the solvent is substantially 0°.

6. The device according to claim 1, wherein the portion of the flat surface that is not in contact with the hollow comprises a shape for storing the solvent.

7. The device according to claim 1, wherein the portion of the flat surface that is not in contact with the hollow comprises a shape for limiting a direction of a flow of the solvent.

8. A method of bonding substrates of a device,
the device comprising:
a first substrate having a flat surface;
a second substrate having a flat surface; and
a recessed portion formed in at least one of the flat surfaces of the first substrate and the second substrate,
the method comprising bonding the flat surfaces of the first substrate and the second substrate together using a solvent to form a hollow therebetween,
wherein a contact angle between a portion of the flat surface in contact with the hollow and the solvent is larger than a contact angle between at least part of a portion of the flat surface that is not in contact with the hollow and the solvent, and
wherein the solvent is supplied to the portion of the flat surface that is not in contact with the hollow to fill the portion of the flat surface in contact with the hollow due to capillary action, to thereby form the hollow.
